(19) United States
(12) Patent Application Publication
(10) Pub. No.: US 2011/0214258 A1
(43) Pub. Date: Sep. 8, 2011

(54) SAFETY DEVICE FOR CORDED WINDOW TREATMENTS

(76) Inventors: Kristi Lee Seymour, Spencer, MA (US); Herbert F. Seymour, III, Spencer, MA (US)

(21) Appl. No.: 13/040,560

(22) Filed: Mar. 4, 2011

Related U.S. Application Data
(60) Provisional application No. 61/339,389, filed on Mar. 4, 2010.

(51) Int. Cl. F16G 11/10; B65H 75/18; F16B 47/00

(52) U.S. Cl. 24/115 F; 242/600; 248/206.2

(57) ABSTRACT

Applicants have disclosed an apparatus and method for avoiding the strangulation of children by dangling cords from window treatments (e.g., window blinds). The preferred apparatus comprises: a substantially flat base; spool means (e.g., a notched spool), extending from an end portion of the base, for physically winding a set of dangling cords (or a looped dangling cord) around from the window treatment; and connection means (e.g., a slide), extending from another end portion of the base, for connecting the apparatus, with the wound cord, into an uncovered top bracket for the window treatment. The preferred connection means is a slide, which either slides or clips into the uncovered bracket. For instances where brackets are unavailable (e.g., Roman shades or some mini-blinds), a suction cup can be used to attach the apparatus to the window frame or window, adjacent the highest point of the window treatment.

### FIELD OF INVENTION

This invention relates in general to child safety devices used in homes. More particularly, it relates to safety devices used for corded window treatments.

### RELATED APPLICATION

This application claims priority from Applicants' U.S. Provisional Patent Application Ser. No. 61/339,389, filed Mar. 4, 2010, entitled “CORD CLIP”. Applicants claim the benefit of priority from that provisional application. Applicants also hereby incorporate the disclosure from that earlier application herein by reference.

### BACKGROUND OF THE INVENTION

Hundreds of children have died in the United States from being strangled by corded window treatments. See NEWS from CPSC (i.e., U.S. Consumer Product Safety Commission), “The Number of Children Who Are Strangled in Window Cords Has Been Under-reported According to a new study in JAMA”, Release # 97-136, originally issued Jun. 3, 1997; revised Mar. 28, 2003 (hereinafter “CPSC Release # 97-136”).

According to CPSC Release # 97-136, that study found 49% of the window cord strangulations in the United States are not being reported to the CPSC. The study estimated the total number from 1981 to 1995 was 359. On average, nearly one child is strangled every two weeks in window cords. Almost all of these deaths (93%) were children three years old and under. The oldest was 12 years old, according to Parents for Window Blind Safety.

“Having this study published in a journal as highly regarded as JAMA will help bring attention to a hidden hazard that we have been trying to eliminate since I came to the Consumer Product Safety Commission in 1994,” stated CPSC Chairman Ann Brown in the revised CPSC Release # 97-136 issued in 2003.

In 1995, CPSC tried to work with the window covering industry to redesign new window blinds to eliminate the outer loop on the end of the cords and provide free repair kits so consumers could fix their existing blinds.” See NEWS from CPSC, Release # 01-023, originally issued Nov. 1, 2000; revised Mar. 28, 2003. Yet the hazard persists.

In 2009 alone, the CPSC recalled more than 50 million Roman shades and roll-up blinds—one of the five largest recalls in the agency's 35-year history. The CPSC indicated those products had cords that can get caught around children's necks.

On Jun. 10, 2010, the U.S. Consumer Product Safety Commission and Health Canada announced that IKEA Home Furnishings of Conshohocken, Pa., was expanding a voluntary recall of Roman blinds, roller blinds and roll-up window blinds and shades due to safety issues. The IKEA recall involves about 3 million additional window blinds imported from India, Estonia, China and Poland and sold in IKEA stores from January 1998 through June 2009. The total number of IKEA blinds recalled by the retailer is approximately 4.5 million.

Jennifer C. Kerr of the Associated Press recently reported, “The commission estimates that one child dies every month after strangling on the cords of blinds or Roman shades.” USA Today, Nov. 10, 2010, “Window Shades, Blinds Recalled amid Safety Review”.

According to History of Window Blind Cord Safety in 2000, there were approximately 1 billion mini-blinds throughout the United States. As reported by Laurie Few of CTV News in Toronto, Canada more than 80 million horizontal blinds are sold each year in the United States and Canada. Applicants therefore submit the CPSC's product recalls are only the tip of the iceberg.

According to the U.S. Census Bureau in 2008, the national census displays: over 25 million children under the age of 5; over 19 million children from the ages of 5-9; and over 20 million children up to the age of 14.

Applicants are aware of two marketed products which claim to make corded blinds safer for children: “Blindwinder” by Addico Inc; and “Window Blind Cord Wind-Ups” by Dorel Juvenile Group, Inc. The Blindwinder is similar to a small tape measure device which retracts the cord by pushing a button. As for the Window Blind Cord Wind-Ups, a parent winds up a dangling cord into this unit . . . similar to a yo-yo.

Parents for Window Blind Safety did not recommend either product. That organization only awards its PFWBS seal of approval to “window dressing services and window products that have no exposed cords, looped cords, cord joiners, or any pull cords in excess of 7¼ inches in length or capable of attaining a length greater than 7¼ inches.”

Parents for Window Blind Safety posted a video on Jan. 25, 2010 (see http://pfwbs.blogspot.com/2010/01/window-cord-wind-up-product-review.html) which runs approximately five minutes long. That video educates people on these two products (i.e., Window Blind Cord Wind-Ups and Blindwinder) as still being of concern. Those products, according to the video, still can form a loop that can cause a child to strangle to death.

Accordingly, it is a primary object of the present invention to provide a safety device which can prevent such children from being strangled by dangling cords of window treatments.

It is another general object to provide a related method for preventing such tragedies.

It is a more specific object to provide a safety device, commensurate with the above-listed objects, which is safe and easy to use.

### SUMMARY OF THE INVENTION

Applicants have disclosed a safety device, and related method, to avoid accidental strangulations from dangling cords in window treatments (e.g., window blinds). Applicants' preferred device comprises: spool means for a parent to physically wrap a set of dangling cords (or a looped cord) around without any exposed end of the cord, until the device and the wrapped cords are adjacent the top of the window treatment; and a connection means for then storing the device out of reach from a child. In the preferred embodiment, the connection means slides into a top bracket for a window blind after a bracket cover has been removed. For instances where that connection is not possible, a suction cup is supplied to attach the device out of reach, against the top of the window frame or against the window.

### BRIEF DESCRIPTION OF THE DRAWINGS

The above and other objects will become more readily apparent when the following description is read in conjunction with the accompanying drawings, in which:

FIG. 1 is a perspective view of a safety device, for corded window treatments, constructed in accordance with the present invention;

FIG. 2 is an exploded view of the safety device and an attachable suction cup;

FIG. 3 is a side plan view, taken along line 3-3 of FIG. 1, showing the suction cup in phantom;

FIG. 4 is a partial view of a window blind attached to a window frame;

FIGS. 5-8 show preferred installation steps for the device;

FIG. 9 shows an alternate installation step; and

FIG. 10 shows a window blind with a dangling looped cord.

### DETAILED DESCRIPTION OF THE PREFERRED EMBODIMENTS

Applicants have disclosed a safety device, and related method, to avoid accidental strangulations by children from dangling cords in window treatments (e.g., window blinds and Roman Shades).

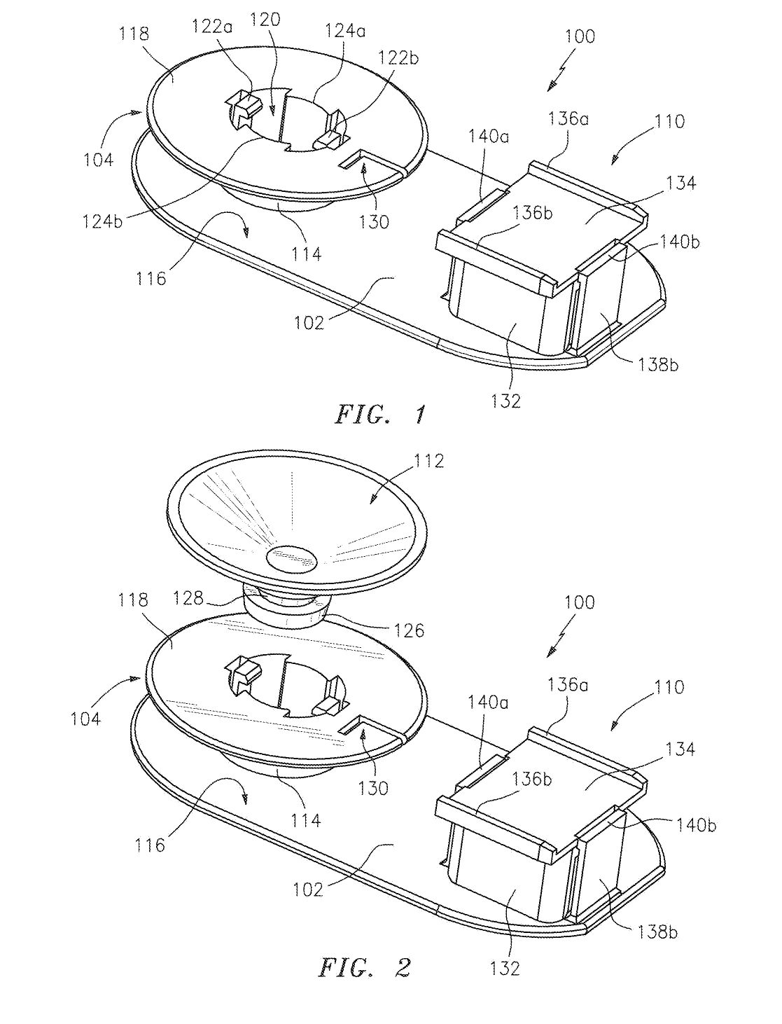

FIGS. 1-3 show Applicants' preferred “apparatus” embodiment. Humble Bee Products, LLC (located in Spencer, Mass.) currently markets that device under the trademark, THE CORD CLIP™.

Applicants′ preferred apparatus or device 100 comprises: a base 102; a spool means (e.g., a notched spool 104), located on the backside of base 102, for a parent or guardian (not shown) to physically wrap a set of cords 106 (or looped cord 107), around from a window treatment (e.g., a window blind 108) without any exposed end(s) of the cord(s), until the device 100 and the wrapped cord(s) (e.g., 106) are adjacent the top of the window treatment (e.g., 108); and connection means (e.g., a slide 110 or a standard suction cup 112), also located on the backside of base 102, for then storing the device 100 out of reach from a child (not shown). All the preferred components of device 100 are plastic.

Spool 104 is exposed (i.e., not covered). It is located at one end portion of base 102.

Spool 104 preferably is formed by a hollow cylindrical member 114 sandwiched between: a top surface 116 of base 102; and a round top 118, which is wider than cylindrical portion 114. Top 118 has a central hole at 120. Four spring clips (i.e., end clips 122a, 122b and side clips 124a, 124b) are located inside the hole, at its perimeter.

End clips 122a, 122b are L-shaped. Vertical stems of the L-shapes are integral with base 102; they extend upwardly toward the spool top 118. Horizontal portions (a.k.a. inturned tips) of the L-shapes face one another, adjacent top 118. Clips 122a, 122b can bend backwards into adjacent notches of the spool 104.

Side clips 124a, 124b are integral with spool top 118; they extend downwardly toward base 102. Side clips 124a, 124b preferably are not L-shaped. Instead, they are vertical with rounded or concave profiles.

Clips 122a, 122b and 124a, 124b are used to attach the suction cup 112 to spool 104. Suction cup 112 has a standard stem 126. Stem 126 has a depressed ring 128 along its midsection. Upon pushing the stem downwardly between clips 122a, 122b and 124a, 124b, the clips spread apart slightly. Continue pushing pops the stem into spool hole 120, as clips 122a, 122b rebound and (their inturned tips) grab the depressed ring 128.

Top 118 of spool 104 preferably has an L-shaped notch 130. This notch is used to hold the end of a wrapped cord 106 away from a child.

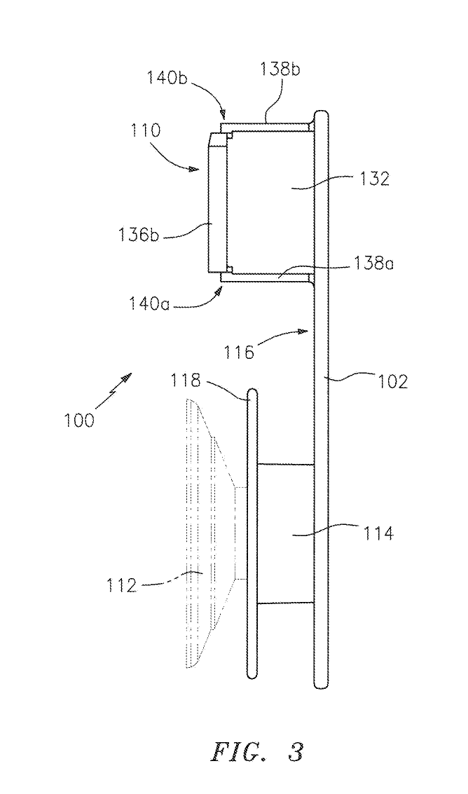

Slide 110 is located at an opposite end portion of base 102. Slide 110 extends upwardly from base 102, as viewed in FIGS. 1-3. Slide 110 comprises: a rectangular block 132; an integral, longer, slide top 134 with upturned ends 136a, 136b; and two side retainers 138a (see FIG. 3), 138b, extending upwardly from base 102, which hold the slide in place. The retainers 138a, 138b have opposing turned-up ends at 140a, 140b which fit into recesses of the rectangular block 130.

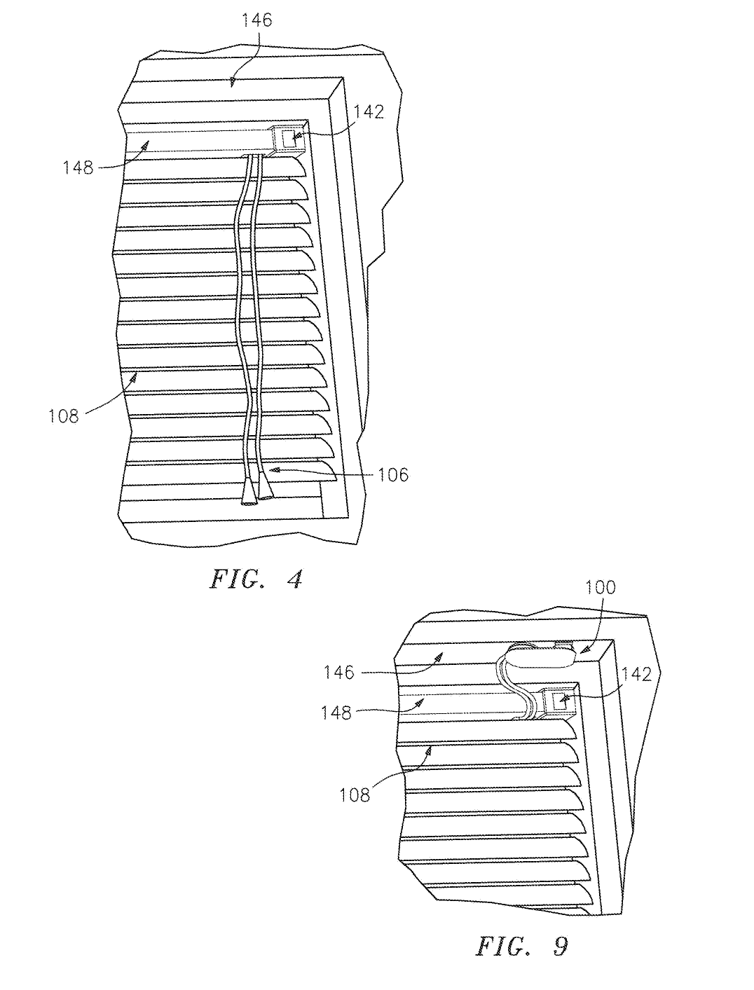

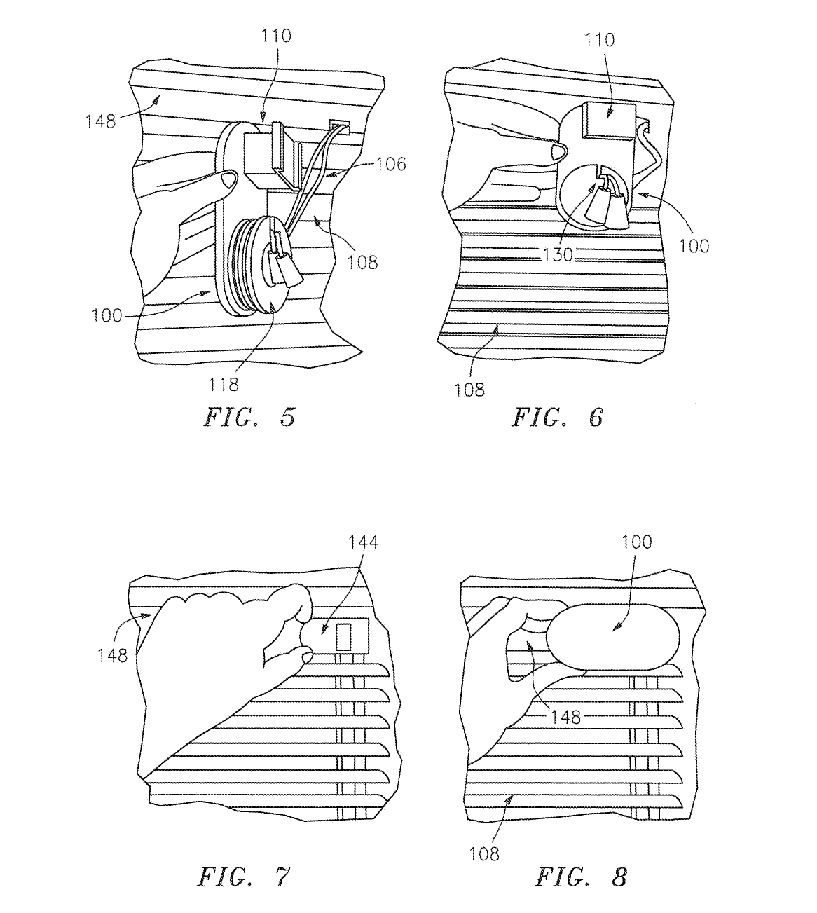

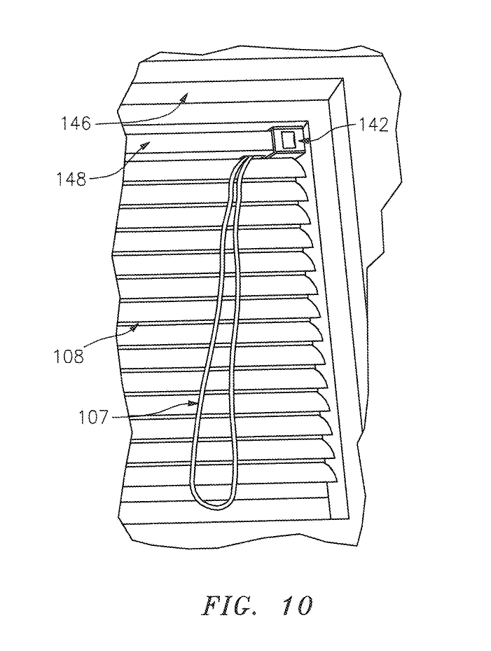

In the preferred embodiment, the slide top 134 is designed to slide onto a bracket 142 for a window blind (e.g. 108) after any bracket cover or clip 144 (see FIG. 4) has been removed. For instances where that connection is not possible, the suction cup 112 can be used to attach the device 100 out of reach, against the top of a window frame 146 or against the window.

The actual product being marketed (i.e., THE CORD CLIP™) is lightweight and small approximately 4 inches in diameter; its base 102 is oval in shape.

### Directions for Use with Window Blinds

Step 1: Wrap a set of dangling cords 106 (or looped cord 107) around the spool 104. Make sure the cords are wound to the highest point of the window blinds 108, the head rail 148. Leave enough room—approximately 2 inches of cords—to move the slide 110 in place (see Step 4 below).

Step 2: Then pull the cords 106 down tightly. Floss the cords in the L-shaped slot/notch 130 to keep the cords 106 from unraveling.

Step 3: Remove the bracket cover/clip 144 from your existing window blind 108 (upper right-hand side, usually).

Step 4: Just slide the slide 110 onto the existing bracket 142 in place of the bracket cover 144.

When properly installed, THE CORD CLIP™ prevents the pull cords 106 from dangling. It also prevents children from accessing cords 106 because there is very little exposed cord length to pull on. The base 102 of THE CORD CLIP™ covers the cord feeder on the head rail!

There is a second way to use this product. Some mini-blinds (not shown) or Roman shades (not shown) may not have the bracket set-up. For those consumers, the suction cup 112 is provided. Just pop in the suction cup 112 into the spool hole 120 located on the back of THE CORD CLIP™. Follow the Steps 1 and 2 above. Then stick the suction cup 112 onto the highest point of the window or frame 146 (see FIG. 4), making sure there is substantially no slack in the wound cord 106.

Some brackets have press-fit or snap-in covers rather than covers slid into place. For those, the slide 110 can be press fit or snapped into place.

It should be understood by those skilled in the art that obvious modifications can be made without departing from the spirit or scope of the invention. For example, a magnet or Velcro® could be used rather than a suction cup. Accordingly, reference should be made primarily to the accompanying claims rather than the foregoing Specification.

Having thus described the invention, we claim:

1. An apparatus for avoiding strangulation from a corded window treatment, the apparatus comprising:
a. a substantially flat base;
b. spool means, extending from an end portion of the base, for physically wrapping around a set of dangling cords from the window treatment;
i. wherein the spool means comprises a spool; and
c. connection means, extending from another end portion of the base, for connecting the device to a bracket for the window treatment.

2. The apparatus of claim 1 wherein the connection means comprises a slide, attached to the base, which slides into the bracket.

3. The apparatus of claim 1 wherein the connection means is press fit into the bracket.

4. The apparatus of claim 1 wherein the spool has a notch for retaining unwound end portions of the cords.

5. The apparatus of claim 4 wherein the notch is L-shaped.

6. An apparatus for avoiding strangulation from a corded window treatment, the apparatus comprising:
a. a substantially flat base;
b. spool means, extending from an end portion of the base, for physically wrapping around a dangling looped cord from the window treatment;
i. wherein the spool means comprises a spool; and
c. connection means, extending from another end portion of the base, for connecting the device to a bracket for the window treatment.

7. An apparatus for avoiding strangulation by a corded window treatment, the apparatus comprising:
a. spool means for physically wrapping a set of dangling cords around from the window treatment;
i. wherein the spool means comprises a spool; and
b. connection means for attaching the device selectively onto an adjacent window frame or an adjacent window;
i. wherein the connection means comprises a suction cup attached to the spool means.

8. The apparatus of claim 7 wherein the spool has a notch for retaining unwound end portions of the cords.

9. An apparatus for avoiding strangulation by a corded window treatment, the apparatus comprising:
a. spool means for physically wrapping a looped dangling cord around from the window treatment;
i. wherein the spool means comprises a spool; and
b. connection means for attaching the device selectively onto an adjacent window frame or an adjacent widow;
i. wherein the connection means comprises a suction cup attached to the spool means.

10. The apparatus of claim 9 wherein the spool has a notch for retaining an unwound portion of the looped cord.

11. A method for preventing strangulation by a corded window treatment, the method comprising:
a. physically winding at least one set of dangling cords, from the window treatment, around a spool until the cords are wound adjacent a top of the window treatment;
b. pulling the wound cords down tightly;
c. placing unwound portions of the cords into a notch in the spool to keep the wound cord from unraveling; and
d. connecting the safety device to a top bracket for the window treatment.

12. The method of claim 11 further comprising removing a cover from the bracket, prior to connecting the safety device onto the bracket.

13. The method of claim 12 wherein step d. further comprises sliding an end portion of the safety device onto the window bracket.

14. The method of claim 12 wherein step d. further comprises press fitting an end portion of the safety device into the uncovered window bracket.

15. A method for avoiding strangulation by a corded window treatment, the method comprising:
a. physically winding at least one dangling cord, from the window treatment, around a spool until the at least one cord is wound adjacent a top of the window treatment;
b. pulling the at least one cord down tightly, after the winding;
c. placing an unwound portion of the at least one cord into a notch in the spool to keep the wound cord from unraveling; and
d. connecting the spool with the wound cord, adjacent the top of the window treatment, via a suction cup.

16. The method of claim 15 wherein the suction cup is attached to a window frame.
